(19) United States
(12) Patent Application Publication
(10) Pub. No.: US 2018/0002025 A1
(43) Pub. Date: Jan. 4, 2018

(54) AIRCRAFT INCLUDING PARALLEL HYBRID GAS TURBINE ELECTRIC PROPULSION SYSTEM

(71) Applicant: United Technologies Corporation, Farmington, CT (US)

(72) Inventors: Charles E. Lents, Amston, CT (US); Larry W. Hardin, East Hartford, CT (US); Jonathan Rheaume, West Hartford, CT (US)

(21) Appl. No.: 15/200,192

(22) Filed: Jul. 1, 2016

(51) Int. Cl. B64D 27/10; B64D 27/24; B64C 25/40; F02C 3/04; F02C 6/14; F01D 15/10; B64D 41/00; B64D 27/02

(52) U.S. Cl. CPC B64D 27/10; F01D 15/10; B64D 27/24; B64D 41/00; B64C 25/405; F02C 3/04; F02C 6/14; B64D 2221/00; B64D 2027/026; F05D 2220/323; Y10S 903/905; Y10S 903/906

(57) ABSTRACT

A gas turbine engine includes a core having a compressor section with a first compressor and a second compressor, and a turbine section with a first turbine and a second turbine. The first compressor is connected to the first turbine via a first shaft and the second compressor is connected to the second turbine via a second shaft. An electric motor is connected to the first shaft such that rotational energy generated by the electric motor is translated to the first shaft. An electric energy storage component is electrically connected to the electric motor, and electrically connected to at least one aircraft taxiing system. The gas turbine engine is configured such that the gas turbine engine requires supplemental power from the electric motor during at least one mode of operations.

### TECHNICAL FIELD

The present disclosure relates generally to hybrid gas turbine electric engines, and more specifically to an aircraft including a hybrid gas turbine electric engine and operations of that aircraft during taxiing.

### BACKGROUND

Gas turbine engines compress air in a compressor section, combine the compressed air with a fuel, ignite the mixture in a combustor section, and expand the resultant combustion products across a turbine section. The expansion of the combustion products drives the turbine section to rotate. The turbine section is connected to the compressor section via one or more shafts, and the rotation of the turbine section drives the rotation of the compressor section. In turbofan gas turbine engines, a fan is similarly connected to a shaft, and driven to rotate by the turbine section. In a geared turbofan, there is a gear set driven by the shaft allowing the fan to rotate at a different (slower) speed than the shaft.

Typical gas turbine engines are designed such that the peak operational efficiency occurs when the engine is operated during one or both of take-off or top of climb (alternately referred to as climb out) conditions. During these conditions, the gas turbine engine requires the maximum amounts of thrust output. The efficiency designs impact the size of the engine components, and the temperatures at which the engine components run during each phase of engine operations. By way of example, during cruise operations, an aircraft requires less thrust, and the gas turbine engine is operated at cooler temperatures. Since the typical gas turbine engine is designed for peak efficiency during take-off or top of climb, where the turbine inlet temperature is at it maximum allowable limit for best efficiency and highest thrust, the gas turbine engine is operated at a lower efficiency during other modes, such as cruise, where the turbine inlet temperature is below the maximum allowable limit.

### SUMMARY OF THE INVENTION

In one exemplary embodiments a gas turbine engine includes a core including a compressor section having a first compressor and a second compressor, a turbine section having a first turbine and a second turbine. The first compressor is connected to the first turbine via a first shaft, the second compressor is connected to the second turbine via a second shaft, an electric motor connected to the first shaft such that rotational energy generated by the electric motor is translated to the first shaft, an electric energy storage component electrically connected to the electric motor, and electrically connected to at least one aircraft taxiing system, and wherein the gas turbine engine is configured such that the gas turbine engine requires supplemental power from the electric motor during at least one mode of operations.

In another example of the above described gas turbine engine the aircraft taxiing system is a traction drive.

In another example of any of the above described gas turbine engines the traction drive is drivably connected to at least one of an aircraft landing gear wheels and transmission.

In another example of any of the above described gas turbine engines the aircraft taxiing system is a fan connected to the first shaft via at least one gearing system.

In another example of any of the above described gas turbine engines the core includes a physical barrier configured to obstruct a primary flowpath inlet to the second compressor in a first position, and to permit air into the primary flowpath inlet in a second position.

In another example of any of the above described gas turbine engines the physical barrier is a variable geometry splitter, and wherein the first position is a closed position, and the second position is an open position.

In another example of any of the above described gas turbine engines a geometry of the gas turbine engine is physically sized such that the turbine inlet temperature of the second turbine is at a maximum while the engine is in a cruise mode of operations.

In another example of any of the above described gas turbine engines a flow rate through the gas turbine engine is configured to be controlled by a controller such that the turbine inlet temperature of the second turbine is at a maximum while the engine is in a cruise mode of operations.

In another example of any of the above described gas turbine engines the electric energy storage component includes sufficient storage capacity to provide supplemental power during take-off and climb out modes and to power a taxi-out via a single charge.

In another example of any of the above described gas turbine engines the electrical energy storage component is a component of a fuel consuming energy generation system.

In another exemplary embodiment an aircraft includes at least one gas turbine engine including a core and a supplementary power motor, a power distribution system electrically connected to the supplementary power motor, and including an energy storage component configured to provide power to, and receive power from, the supplementary power motor, and the at least one gas turbine engine is undersized relative to a required thrust during at least one mode of operations.

In another example of the above described aircraft the at least one mode of operations includes one of a take-off and a climb out mode.

In another example of any of the above described aircrafts the aircraft further includes a plurality of landing gears, and at least one traction drive being mounted to a landing gear, wherein the at least one traction drive is electrically connected to the power distribution system.

In another example of any of the above described aircrafts the electric energy storage component includes sufficient storage capacity to provide supplemental power during take-off and climb out modes and to power a taxi-out via a single charge.

In another example of any of the above described aircrafts a fan in the gas turbine engine is operated during a taxi mode of operation, and air is prevented from entering at least a portion of the core during the taxi mode of operation.

In another example of any of the above described aircrafts the supplementary power motor is an electric motor/generator.

In another example of any of the above described aircrafts the energy storage component is a rechargeable battery.

An exemplary method of operating a gas turbine engine includes providing power to a taxiing system using an electric motor during a taxi mode of operation, providing thrust from fan rotation during at least one of a take-off and climb mode of operations, wherein the fan is rotated by a turbine and the electric motor simultaneously, and providing thrust from fan rotation during a cruise mode of operation, wherein the fan is rotated exclusively by the turbine.

In another example of the above described method of operating a gas turbine engine providing power to the taxiing system comprises driving an electric traction drive connected to a landing gear.

In another example of any of the above described methods of operating a gas turbine engine providing power to the taxiing system comprises driving the fan to rotate using only the electric motor.

In another example of any of the above described methods of operating a gas turbine engine providing thrust from fan rotation during the cruise mode of operation comprises operating an engine core at a maximum high pressure turbine inlet temperature during the cruise mode of operation.

These and other features of the present invention can be best understood from the following specification and drawings, the following of which is a brief description.

### BRIEF DESCRIPTION OF THE DRAWINGS

FIG. 1 schematically illustrates an exemplary gas turbine engine according to one embodiment.

FIG. 2 schematically illustrates an aircraft including the exemplary gas turbine engine of FIG. 1.

FIG. 3 illustrates a method for operating the aircraft of FIG. 2.

### DETAILED DESCRIPTION OF AN EMBODIMENT

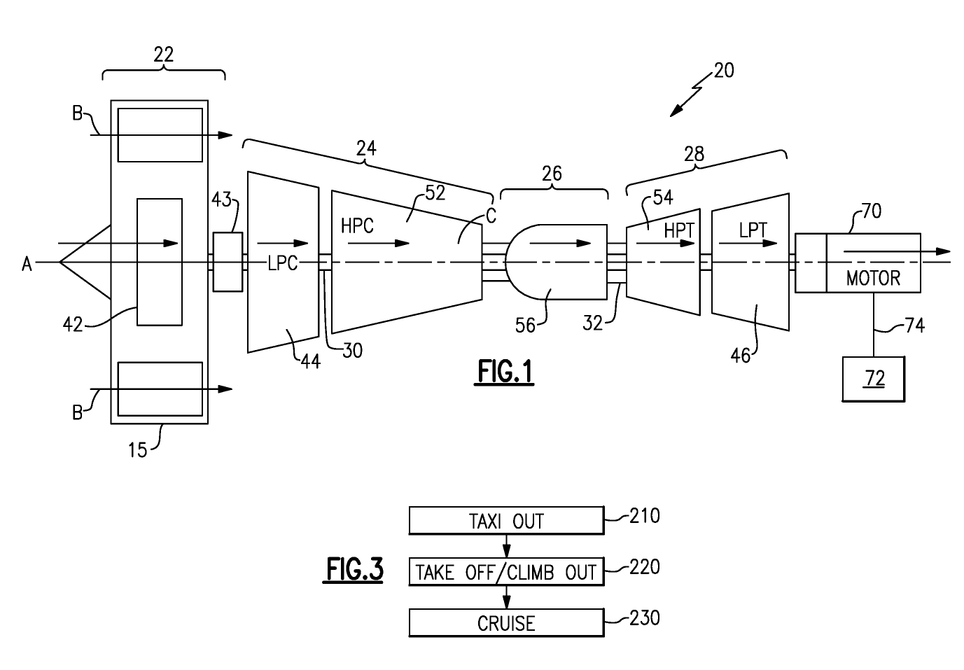

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures and geared turbofan architectures.

The exemplary engine 20 generally includes a low speed spool 30 and a high speed spool 32 mounted for rotation about an engine central longitudinal axis A relative to an engine static structure via several bearing systems. It should be understood that various bearing systems at various locations may be provided.

The low speed spool 30 generally includes an inner shaft that interconnects a fan 42, a first (or low) pressure compressor 44 and a first (or low) pressure turbine 46. The inner shaft is connected to the fan 42 through a gear system 43, which in exemplary gas turbine engine 20 is illustrated as a geared architecture to drive the fan 42 at a lower speed than the low speed spool 30. The high speed spool 32 includes an outer shaft that interconnects a second (or high) pressure compressor 52 and a second (or high) pressure turbine 54. A combustor 56 is arranged in the exemplary gas turbine 20 between the high pressure compressor 52 and the high pressure turbine 54. In some examples, a mid-turbine frame of the engine static structure is arranged generally between the high pressure turbine 54 and the low pressure turbine 46. The mid-turbine frame further supports bearing systems within the turbine section 28. The inner shaft and the outer shaft are concentric and rotate via bearing systems about the engine central longitudinal axis A, which is collinear with the longitudinal axes of the inner shaft and the outer shaft.

The core airflow is compressed by the low pressure compressor 44 then the high pressure compressor 52, mixed and burned with fuel in the combustor 56, then expanded over the high pressure turbine 54 and low pressure turbine 46. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 43 may be varied. For example, gear system 43 may be located aft of combustor section 26 or even aft of turbine section 28, and fan section 22 may be positioned forward or aft of the location of gear system 43.

The engine 20 in one example is a high-bypass geared aircraft engine. In a further example, the engine 20 bypass ratio is greater than about six (6), with an example embodiment being greater than about ten (10), the geared architecture 43 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five (5:1). Low pressure turbine 46 pressure ratio is the pressure measured prior to the inlet of the low pressure turbine 46 as related to the pressure at the outlet of the low pressure turbine 46 prior to an exhaust nozzle. The gear system 43 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

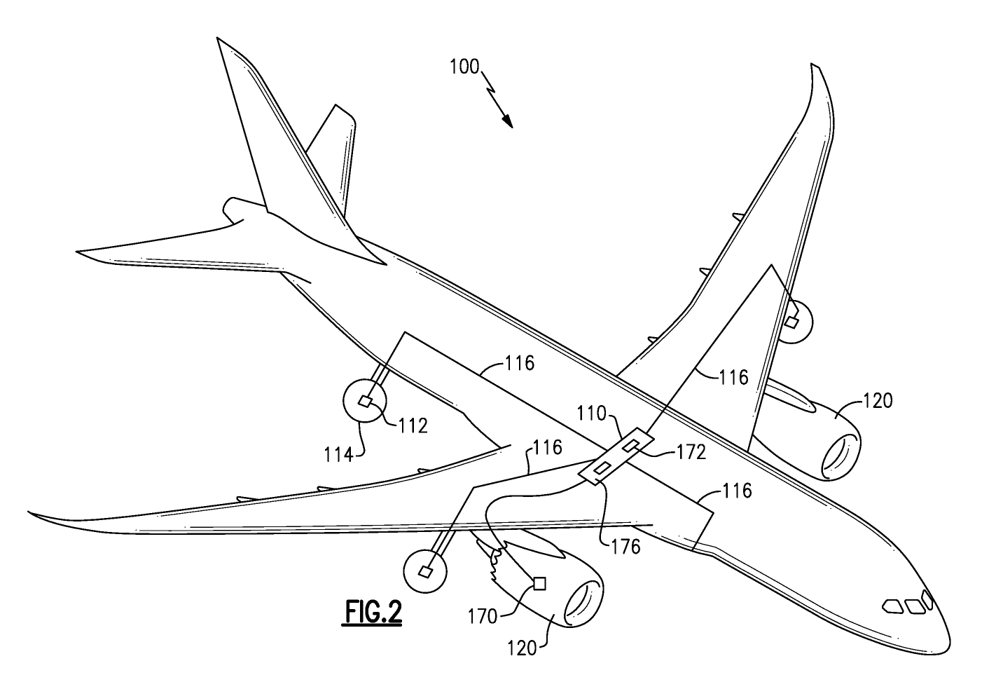

In some examples, an electric motor/generator 70 is incorporated into the engine 20 and is capable of generating rotational power using electricity provided by an electric energy source. In some examples, a motor/generator can be utilized as a motor/generator 70 and electric energy can be generated by rotational energy from the low speed spool 30. In such an example, the electric energy can be provided to an energy storage system 72 connected to the motor/generator 70 via an electrical connection 74. In some examples, such as the example described below with regards to FIG. 2, the energy storage system 72 can be incorporated into an aircraft power distribution system. In other examples, the energy storage system can be self-contained within the engine 20, and does not interface with an overall aircraft electrical power system. In either example, the energy storage system 72 can include a charging port allowing the energy storage system to be charged while the aircraft is parked on the ground, as well as allowing energy from the motor/generator 70 to charge the energy storage system 72 during aircraft operations.

In order to increase the efficiency of the engine 20, relative to standard gas turbine engines, the engine core is sized such that the engine operates at a maximum allowable high pressure turbine 54 inlet temperature during maximum cruise thrust operations. As utilized herein, the sizing of the core can refer to a physical size of the primary flowpath C and the core components, a controller engine scheduling, or both.

Take-off and climb out, among other possible modes of operation, require more thrust than the cruise mode. Since the engine 20 is operating at maximum efficiency during the cruise mode, the engine sizing is not adequate to provide necessary thrust for proper operations during take-off and climb out using the turbines 54, 46 alone. In order to provide sufficient rotation to the fan 42 for proper operations, the energy storage component 72 provides electricity to the motor/generator 70, thereby driving the motor/generator 70 to rotate, and imparting rotational motion onto the low speed spool 30. The rotational motion is added to the rotation from the low pressure turbine 46, and translated to the fan 42 through the gear system 43. The combination of the rotation from the turbine section 46 and from the motor/generator 70 is sufficient to enable take-off and climb out operations.

While illustrated in the example of FIG. 1 as being positioned aft of the low pressure turbine 46, one of skill in the art, having the benefit of this disclosure, will understand that the motor/generator 70 can be placed at alternative axial positions within the gas turbine engine, and provide similar functions.

In order to further reduce fuel utilization, and increase efficiency of the aircraft including the engine 20, the turbine portions of the engine 20 are not utilized while the aircraft is taxing out to a take-off position, or taxiing in to a parked position. Instead, the energy storage component 72 provides an electric output to the motor/generator 70, thereby driving the low speed spool 30 to rotate. Rotation of the low speed spool 30 drives the fan 42 to rotate, and generates sufficient thrust to taxi the aircraft either to a take-off position (during taxi out) or to a parked position (during taxi in). It is understood that in practical examples the engine requires warm up time, so electric taxi out will end prior to take-off, with the delay between end of electric taxi out and take off being approximately the same as an engine warm up time. In order to increase the efficiency of the motor/generator 70, in some examples, a physically barrier is placed in the primary flowpath, thereby preventing airflow into the core during taxiing operations. By way of example, the physical barrier can be an iris that is closed during taxiing.

As there is no point between the beginning of the taxiing out and entering the cruise mode of operations where the engine 20 motor/generator 70 can charge the energy storage system 72, the energy storage system includes sufficient storage capacity to provide supplemental power during take-off and climb out modes and to power the taxi-out via a single charge. In a practical example, the energy storage device 72 will include excess capacity beyond the minimum necessary for take-off climb out and taxi-out, in order to account for any unforeseen power needs or expenditures. In some examples, the energy storage device 72 can be a component of a fuel consuming energy generation system, such as an internal combustion engine operating using jet fuel. In such an example, the combustion engine can be utilized to generate electricity, which is in turn utilized to power the energy storage device 72.

With continued reference to FIG. 1, FIG. 2 schematically illustrates an aircraft 100 including aircraft engines 120, according to the example engine 20 of FIG. 1. Each of the engines 120 includes a motor/generator 170 electrically connected to a power distribution system 110. Included within the power distribution system 110 is an energy storage component 172 capable of storing power generated by the electric motor/generator 170, and returning the stored power to the power distribution system 110.

Unlike the example implementation described above with regards to FIG. 1, the aircraft 100 of FIG. 2 utilizes a traction drive 112 connected to one or more of the landing gears 114 in order to provide taxiing power. The traction drives 112 are connected to the power distribution system 110 via electrical connections 116, and receive electrical power from the energy storage component 172. During a taxi-out operation, or a taxi-in operation, the motor/generator 170 is not provided any power, and the engine 120 is not operated. Instead, electrical power is provided to the traction drives 112, which provide rotation to the landing gears wheels 114 or landing gear transmission, and allow the aircraft to properly taxi. As with the example of FIG. 1, the energy storage component 172 is sufficiently sized to provide supplemental power during take-off and climb out modes and to power the taxi-out via a single charge.

In order to facilitate the operations of the power distribution system 110, a controller 176 is incorporated into the power distribution system 110. In some examples the controller 176 is a dedicated controller configured to control power into and out of the power distribution system 110. In alternative examples the controller 176 is a general aircraft controller, and performs other aircraft control functions as well. In yet further examples, such as the example engine 20 of FIG. 1, the controller 176 can be located within the aircraft engine 20 and control only the components included in the engine 20.

With continued reference to FIGS. 1 and 2, FIG. 3 illustrates a method 200 of operating a gas turbine engine, such as the gas turbine engine 20, during the initial portions of a given flight. Initially a controller places the engine in a taxi out mode, and the aircraft taxis out to a take-off position in a “taxi out” step 210. The taxiing is achieved exclusively using electrical power from the energy storage component 72, 172, subject to the warm-up constraints discussed above.

Once at the initial take-off position, the controller transitions the engine 20 to a take-off/climb out mode in a “take-off/climb out” step 220. During take-off and climb out, the engine 20 is operated at peak efficiency. Due to the sizing of the engine 20, the peak efficiency point provides the thrust required to maintain the aircraft at cruise conditions. In order to facilitate the higher thrust requirements of take-off/climb out, the energy storage system 72, 172 provides electrical power to the motor/generator 70, 170, and rotational power is added to the low speed spool 30. The combination of the rotation from the turbine section 28 and the motor/generator 70, provides sufficient rotation to the fan 42 to generate the thrust requirements for take-off and climb out.

Once at altitude, the controller transitions the engine operations to cruise mode in a “cruise” step 230. During cruise mode, the engine is operated at maximum temperature and efficiency, and no supplementary power from the motor/generator 70, 170 is required. In some examples, the motor/generator 70 can be operated as a generator during cruise mode, and the energy storage component 72, 172 can be recharged during flight. In alternative examples, the energy storage component 72, 172 can be recharged during other modes of operation, or after the aircraft has landed.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine comprising:
a core including a compressor section having a first compressor and a second compressor, a turbine section having a first turbine and a second turbine;
the first compressor is connected to the first turbine via a first shaft;
the second compressor is connected to the second turbine via a second shaft;
an electric motor connected to the first shaft such that rotational energy generated by the electric motor is translated to the first shaft;
an electric energy storage component electrically connected to said electric motor, and electrically connected to at least one aircraft taxiing system; and
wherein the gas turbine engine is configured such that the gas turbine engine requires supplemental power from the electric motor during at least one mode of operations.

2. The gas turbine engine of claim 1, wherein the aircraft taxiing system is a traction drive.

3. The gas turbine engine of claim 2, wherein the traction drive is drivably connected to at least one of an aircraft landing gear wheels and transmission.

4. The gas turbine engine of claim 1, wherein the aircraft taxiing system is a fan connected to said first shaft via at least one gearing system.

5. The gas turbine engine of claim 4, wherein the core includes a physical barrier configured to obstruct a primary flowpath inlet to said second compressor in a first position, and to permit air into said primary flowpath inlet in a second position.

6. The gas turbine engine of claim 5, wherein the physical barrier is a variable geometry splitter, and wherein the first position is a closed position, and the second position is an open position.

7. The gas turbine engine of claim 1, wherein a geometry of the gas turbine engine is physically sized such that the turbine inlet temperature of the second turbine is at a maximum while said engine is in a cruise mode of operations.

8. The gas turbine engine of claim 1, wherein a flow rate through the gas turbine engine is configured to be controlled by a controller such that the turbine inlet temperature of the second turbine is at a maximum while said engine is in a cruise mode of operations.

9. The gas turbine engine of claim 1, wherein the electric energy storage component includes sufficient storage capacity to provide supplemental power during take-off and climb out modes and to power a taxi-out via a single charge.

10. The gas turbine engine of claim 1, wherein the electrical energy storage component is a component of a fuel consuming energy generation system.

11. An aircraft comprising:
at least one gas turbine engine including a core and a supplementary power motor;
a power distribution system electrically connected to the supplementary power motor, and including an energy storage component configured to provide power to, and receive power from, the supplementary power motor; and
the at least one gas turbine engine is undersized relative to a required thrust during at least one mode of operations.

12. The aircraft of claim 11, wherein the at least one mode of operations includes one of a take-off and a climb out mode.

13. The aircraft of claim 11, wherein the aircraft further comprises a plurality of landing gears, and at least one traction drive being mounted to a landing gear, wherein the at least one traction drive is electrically connected to the power distribution system.

14. The aircraft of claim 11, wherein the electric energy storage component includes sufficient storage capacity to provide supplemental power during take-off and climb out modes and to power a taxi-out via a single charge.

15. The aircraft of claim 11, wherein a fan in said gas turbine engine is operated during a taxi mode of operation, and air is prevented from entering at least a portion of said core during the taxi mode of operation.

16. The aircraft of claim 11, wherein the supplementary power motor is an electric motor/generator.

17. The aircraft of claim 11, wherein the energy storage component is a rechargeable battery.

18. A method of operating a gas turbine engine comprising:
providing power to a taxiing system using an electric motor during a taxi mode of operation;
providing thrust from fan rotation during at least one of a take-off and climb mode of operations, wherein the fan is rotated by a turbine and the electric motor simultaneously; and
providing thrust from fan rotation during a cruise mode of operation, wherein the fan is rotated exclusively by the turbine.

19. The method of claim 18, wherein providing power to the taxiing system comprises driving an electric traction drive connected to a landing gear.

20. The method of claim 18, wherein providing power to the taxiing system comprises driving the fan to rotate using only the electric motor.

21. The method of claim 18, wherein providing thrust from fan rotation during the cruise mode of operation comprises operating an engine core at a maximum high pressure turbine inlet temperature during the cruise mode of operation.
